(19) United States
(12) Patent Application Publication
(10) Pub. No.: US 2006/0048207 A1
(43) Pub. Date: Mar. 2, 2006

(54) Voice-Operated Television with Telephone, Digital Video Recording and Weather Alert Functions

(76) Inventor: Alexander Martin, Decatur, IL (US)

Correspondence Address: TODD R. WILKINSON, 423 S. WATER ST., DECATUR, IL, 62523-1492, US

(21) Appl. No.: 11/161,916

(22) Filed: Aug. 22, 2005

Related U.S. Application Data
(60) Provisional application No. 60/604,805, filed on Aug. 27, 2004.

(51) Int. Cl. H04M 11/00; H04N 7/16; H04N 7/173

(52) U.S. Cl. 725/135; 379/102.03; 725/133; 725/141

(57) ABSTRACT

The present invention is a television set that is operated by voice commands without the use of a remote control as is typical in the art. The device also is multifunctional in combining television viewing capabilities, with voice telephone sending and receiving capabilities, digital video recording capabilities and weather alert indications. All of these functions are combined into a single device. The present invention makes improvements on those known in the art by eliminating the need for any second control device (e.g. remote control) and combining many devices into a single device that can be controlled by the user's voice commands.

### CROSS REFERENCE TO RELATED APPLICATION

This application claims priority to and is a nonprovisional application of Application No. 60/604,805 filed on Aug. 27, 2004.

### Background of the Invention and Prior Art Disclosures

1. Technical Field

The present invention relates to a television system and is particularly directed to the enhancement of the utility of known television systems.

2. Description of the Prior Art

Televisions, television sets, television receivers or television units are all know to refer to common devices which can display programming to a user including visual moving pictures and audio sounds for entertainment and information. Many types of systems are known in the art for the control and added capability of a standard television set. These include the use of a remote control to allow the user to remain at a distance from the television while controlling the television's functions. Also included is the addition of external devices connected to the television to add the ability to digitally record programming in stored memory for later playback or to display a visual message on the television screen indicating an incoming telephone call. Another example is the combining of a television with a weather radio to allow the user to know of weather alerts while using the television. The prior art shows the demand for standard television systems to include increased functionality and ease of use.

Digital video recorder systems are known in the art as systems or devices capable of storing television programming on fixed or removable media for later playback on a television set. An example of such a device is that disclosed by US Patent to Windrem, et al U.S. Pat. No. 6,526,225. These devices are known to be external to the television set each having its own method for control and being independent of the television set itself.

Weather alert systems are known in the art to be systems or devices capable of detecting broadcast signals which indicate local weather alerts and of then performing an alert function such as tuning a television to a specific channel or giving a visual or audio cue to the user of the device. An example of such a device is that disclosed by US Patent to Vanderable—U.S. Pat. No. 6,204,761.

Also known in the art are various systems, devices and methods providing for voice operation of televisions. A voice-operated remote control for a television set is known in the art as disclosed by U.S. Pat. No. 6,606,280 to Knittel. This device is one that is external to the television and serves to replace existing remote television control devices. Also known is a method and apparatus for voice control of a television control device as disclosed by U.S. Patent Application No. 20030167171 to Calderon, Theodore; et al and a system and method for voice controlled video screen display as disclosed by U.S. Pat. No. 5,890,123 to Brown et al.

Televisions that provide telephone functions are also known in the art. Various devices and systems provide for the ability to use a television for notifying the user of incoming calls and the use of microphones and speakers built-in to the television for actually conducting the phone call. Some typical inventions are those disclosed by U.S. Pat. No. 4,349,701 to Snopko, Japanese Patent No. JP19940071778 to Satoshi and U.S. Application No. 20010855839 to Brunelle and Brockenbrough.

### SUMMARY OF THE INVENTION

An apparatus is disclosed which adds new functionality to a standard television by combing a television set, a digital video recorder system, a weather alert system, and a telephone system into a single unit which is controlled by the user's voice-commands. A voice command is spoken by the user and detected by a microphone in the device and processed by the device such that the intended function is performed. The user can control the functioning of the television, the digital video recorder system, the weather alert system, and the voice telephone system with voice-commands specific to each type of function. The apparatus thereby can be operated to display television programming, to record and review digitally recorded television programming, to indicate the presence of a local weather alert as determined by local weather radio or television signals, and to receive and send telephone calls. Such a device is unknown in the art and adds utility over existing devices and inventions in that it is a more compact and convenient device that would allow the user to have only one electronic device and to be able to control it completely by voice command.

It is a purpose of this invention to provide a television device which can record and playback television programming with a built-in digital video recorder system.

It is an additional purpose of this invention to provide a television device which can provide the user with a weather alert.

It is an additional purpose of this invention to provide a television device which can receive and send telephone calls.

It is an additional purpose of this invention to provide a television device which is voice-operated.

### BRIEF DESCRIPTION OF THE DRAWINGS

FIG. 1 is a block diagram illustrating elements of the voice-operated television device according to the invention;

FIG. 2 is a diagram illustrating a preferred embodiment of the voice-operated television device according to the invention

### DESCRIPTION OF THE PREFERRED EMBODIMENT

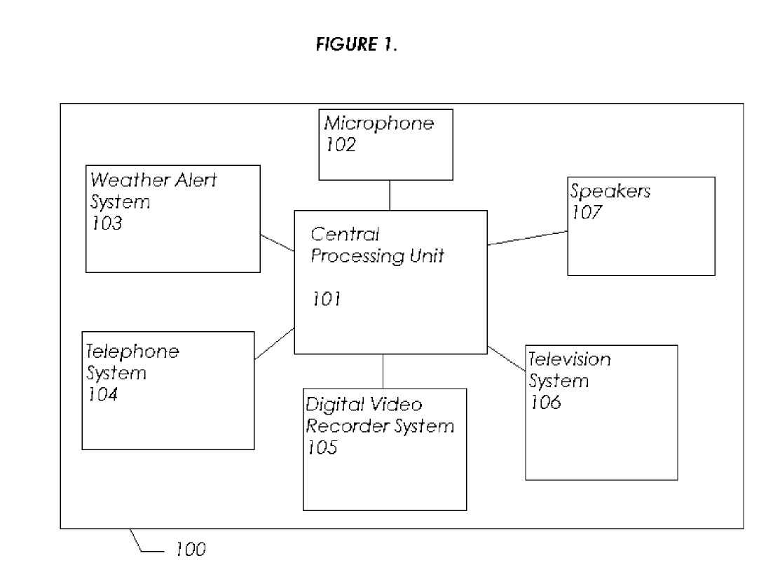

FIG. 1 is a diagram showing the features of the invention as one skilled in the art may understand to show the combination of features of the invention. The housing (100) of the invention encloses the various components of the invention. The device is controlled by a central processing unit (101). In direct connection to the central processing unit (101) and in communication therewith, are a weather alert system (103), a telephone system (104), a digital video recorder system (105), a television system (106), and one or more speakers (107). A microphone (102) receives the audio commands from the user which are then processed by the central processing unit (101) which in turn activates one of the other systems or devices connected thereto according to the command spoken by the user.

The central processing unit (101) is one that is known in the art to be capable of processing input and creating output sufficient to control the systems of the invention. It would be capable of processing voice-command input from the microphone of the invention and determining what the intended result is from the user. The central processing unit of the invention would include sufficient software to effect the purposes of the invention as set forth herein. A user interface would be provided by the software to assist the user in controlling the invention and would provide additional functionality. The voice-command functionality of the invention would be sufficient to operate all the various systems included in the invention and all of the subfunctions of those systems.

The television system (106) of this invention is one that would be known in the art to have a tuner, video screen, and controls for volume and channel changing as well as input jacks for the connection of external devices (not shown in this figure). Also typical of known television systems is to use indicator lights (not shown) that would signal the user that the system is in active or standby mode.

The speakers (107) of this invention are typical speakers as are known in the art to be able to reproduce sounds.

The weather alert system (103) of this invention is one that would have functionality, as is known in the art, to receive broadcast signals of weather alerts and then to notify the user by giving a visual or audio signal such as by an indicator light (not shown in this figure), display on the video screen of the television system (106) or audio alarm through the speakers (107).

The telephone system (104) of this invention is one that is known in the art to be able to receive and place telephone calls through local telephone networks. In the present invention the microphone (102) and speakers (107) would be utilized to allow the invention to be used like a speakerphone as is known in the art.

The digital video recorder system (105) of this invention is one that is known in the art to be able to record, store, and playback television programming. Also typical of this system as is known in the art is the use of indicator lights (not shown in this figure) to signal the user that the device is recording or playing back programming.

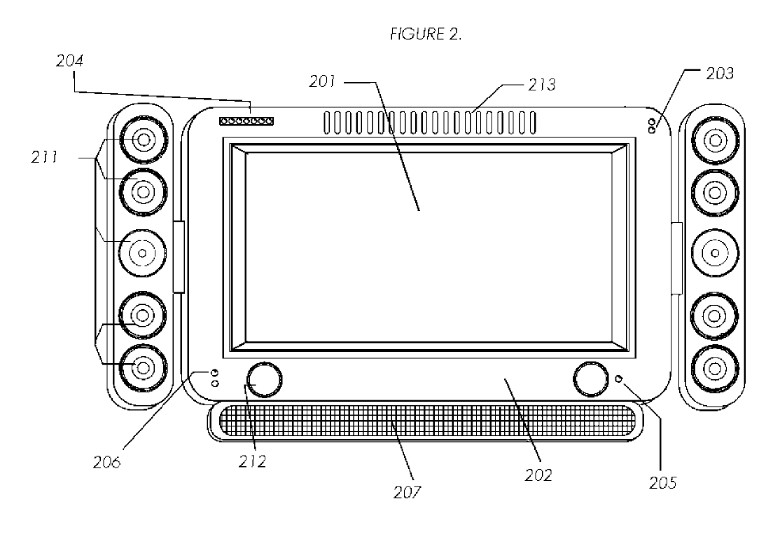

FIG. 2 shows a perspective view of the invention in a preferred form and shows the face of the invention or the side to be viewed by the user. The figure shows how the invention combines many functions into a single unit. The components of the invention are located inside the housing (202) and are not shown in this figure. What is shown is a location provided on the face of the unit for a video screen (201) of the television system such as a cathode ray tube or any one of a number of flat screen technologies including but not limited to LCD screens, TFT screens and plasma screens in either standard or high definition forms. Also located on the face of the invention is a means for visually indicating to the user that a specific function of the invention is active. Power indicator lights (204) show that the unit detects a weather alert signal. Telephone indicator light (205) shows that the telephone functions of the invention are in use. Recorder indicator lights (206) show that the unit is currently recording or is set to record television programming with the built-in digital video recorder. The unit also includes a location for a microphone (207) to receive voice commands. Also included are one or more speakers for the reproduction of sounds from the television, telephone or other functions of the invention. The location of these speakers is shown in the preferred form in this figure to be side speakers (211), bottom speakers (212), and top speakers (213).

What has been described above is a preferred embodiment of the present invention. It is not possible to describe every conceivable combination, modification, or permutation of the present invention. However, one skilled in the art will recognize that such combinations, etc. are possible. Therefore, all such combinations, etc. are to be included within the scope of the present invention as defined by the claims.

What is claimed is:

1. A voice-operated television device adapted for use in placing and receiving telephone calls, recording and playing-back television programming, viewing television programming, and receiving and viewing weather alert information, comprising:
A housing that supports and protects the other systems and parts of the device;
A television system that displays video information from a source;
A microphone that produces an output from a received sound;
A telephone system that receives and places telephone calls;
A weather alert system that receives broadcast signals and gives alerts regarding local weather conditions;
A digital video recorder system that records television programming for later review;
A central processing unit that processes input from the microphone and controls the other systems of the invention; and
One or more speakers.

2. The device of claim 1, wherein said television system includes a cathode ray tube video screen.

3. The device of claim 1, wherein said television system includes a flat screen technology video screen.

4. The device of claim 1, wherein said television system includes a high definition video screen.

5. The device of claim 1, wherein said weather alert system includes a weather radio that receives and reproduces broadcast weather alert radio programming.

6. The device of claim 1, wherein said digital video recorder system includes a hard drive storage unit for storage of digitally recorded television programming.

7. The device of claim 1 wherein said digital video recorder system includes a removable media writing system for storage of television programming on removable media.

8. The device of claim 1, wherein said one or more speakers is two speakers.

9. A voice-operated television device adapted for use in placing and receiving telephone calls, recording and playing back television programming, viewing television programming, and receiving and viewing weather alert information, comprising:
A housing that supports and protects the other systems and parts of the device;
A television system that displays video information from a source and includes a flat screen technology video screen;
A microphone that produces an output from a received sound;
A telephone system that receives and places telephone calls by speakerphone technology;
A weather alert system that receives broadcast signals and gives alerts regarding local weather conditions;
A digital video recorder system that records television programming for later review including a hard drive storage medium;
A central processing unit that processes input from the microphone and controls the other systems of the invention; and
One or more speakers.

10. The device of claim 9, wherein said weather alert system includes a weather radio that receives and reproduces broadcast weather alert radio programming.

11. The device of claim 9, wherein said flat screen technology video screen is a liquid crystal display.

12. The device of claim 9, wherein said flat screen technology video screen is a plasma screen.

13. The device of claim 9, wherein said flat screen technology video screen is a high definition video screen.

14. The device of claim 9, wherein said one or more speakers is two speakers.

15. A television receiver which is voice operated comprising a cabinet which houses a television system, a telephone system, a digital video recorder system, a weather alert system, a central processing unit, a microphone, and one or more speakers.

16. The television receiver according to claim 15, wherein said television system includes:
A video screen;
A means for receiving television programming signals;
A means for processing television programming signals;
A means for displaying television programming signals on said video screen; and
A means for controlling the channel and volume of displayed television programming signals.

17. The television receiver according to claim 15, wherein said telephone system includes:
A microphone;
A speaker;
A means for receiving sounds;
A means for processing sounds;
A means for producing sounds;
A means for receiving telephone calls from a telephone network;
A means for conducting telephone calls on a telephone network; and
A means for initiating telephone calls on a telephone network.

18. The television receiver according to claim 15, wherein said digital video recording system includes:
A digital recording medium for storage of digitally recorded television programming;
A means for recording a television programming signal; and
A means for replaying a recorded television programming signal.

19. The television receiver according to claim 15, wherein said weather alert system includes:
A means for detecting a broadcast weather alert signal;
A means for visually indicating the presence of the broadcast weather alert signal to a user; and
A means for aurally indicating the presence of the broadcast weather alert signal to the user.

20. The television receiver according to claim 15, wherein said central processing unit includes:
A processor;
A memory unit;
A software program;
A means for processing an input;
A means for decoding an input from the microphone;
A means for providing a user interface; and
A means for controlling the functions of the television system, telephone system, weather alert system, and digital video recording system of the television receiver.
